(19) United States
(12) Patent Application Publication
(10) Pub. No.: US 2026/0113817 A1
(43) Pub. Date: Apr. 23, 2026

(54) AUXILIARY HEATING ASSEMBLY WITH COMPLIANT CONNECTION COMPONENT

(71) Applicant: WHIRLPOOL CORPORATION, BENTON HARBOR, MI (US)

(72) Inventors: Ge Lin, Shenzhen (CN); Li Xin, Shenzhen (CN)

(73) Assignee: WHIRLPOOL CORPORATION, BENTON HARBOR, MI (US)

(21) Appl. No.: 19/113,336

(22) PCT Filed: Sep. 20, 2022
(86) PCT No.: PCT/CN2022/119803

§ 371 Date: Mar. 19, 2025

(51) Int. Cl. H05B 6/64; H05B 3/74; H05B 6/72; H05B 6/76

(52) U.S. Cl. CPC H05B 6/647; H05B 3/748; H05B 6/72; H05B 6/76; H05B 2203/008; H05B 2203/013; H05B 2203/016

(57) ABSTRACT

A microwave oven includes a housing defining a cooking cavity and a component cavity external to the cooking cavity and a heating plate fixedly supported within the cooking cavity on a lower surface thereof and including an electric heating element disposed on at least a portion of the heating plate and defining first and second electric contact elements on an underside thereof. A pair of conductive connection elements are mounted within the component cavity and extend through the lower surface of the cooking cavity to define respective ends of the conductive connection elements that are moveable with respect to the lower surface of the cooking cavity and are in contact with the first and second electric contact elements of the heating plate.

### BACKGROUND OF THE DISCLOSURE

The present disclosure generally relates to an auxiliary heating assembly for a microwave oven, and more specifically, to compliant connection components for a heating plate.

Some microwaves have incorporated an upper heating element (such as a quartz heating tube) for directing radiant heat downward toward food items within the microwave cavity to provide a broil/grill or crisping cooking modes. It can be appreciated, however, that such a solution only radiates heat to one side (i.e., the upper side) of the food items, leaving the other side to be cooked only by the microwaves. Some other existing solutions have added additional heating elements below a lower surface of the cooking cavity (which may be made of glass). To allow effective microwave penetration into the cavity, however, such heating elements must be positioned to the rear of the cavity, which prevents the lower heating element from providing beneficial heating to the bottom portion of food articles. A microwave oven that includes a glass plate with a resistive heating coating on an underside thereof can be used as a way to provide even heating along the underside of food products, while still allowing micro-wave penetration into the cooking cavity. This arrangement can allow for supplemental heating of food inside the cavity, in addition to the microwave heating provided by the magnetron and/or crisping of the undersides of food products. Such heating plates can be connected to the power source of the microwave oven by solder joints between the wire leads and conductive pads on the crisp plate (that are electrically connected to or are incorporated in the coating). Such joints, however, are subject to failure due to potential melting of the solder caused by the heat that the plate produces, as well as disconnection due to thermal deformation of the crisp plate during repeated heat-cycling thereof.

### SUMMARY OF THE DISCLOSURE

According to one aspect of the present disclosure, a microwave oven includes a housing defining a cooking cavity and a component cavity external to the cooking cavity and a heating plate fixedly supported within the cooking cavity on a lower surface thereof and including an electric heating element disposed on at least a portion of the heating plate and defining first and second electric contact elements on an underside thereof. A pair of conductive connection elements are mounted within the component cavity and extend through the lower surface of the cooking cavity to define respective ends of the conductive connection elements that are moveable with respect to the lower surface of the cooking cavity and are in contact with the first and second electric contact elements of the heating plate.

According to another aspect of the present disclosure, an auxiliary heating assembly for a cooking appliance having a housing defining a cooking cavity and a component cavity external to the cooking cavity includes a heating plate fixedly supported within the cooking cavity on a lower surface thereof and having an electric heating element disposed on at least a portion of the heating plate and defining first and second electric contact elements on an underside thereof and a connection assembly to provide electricity to the electric heating element of the heating plate. The connection assembly includes a connection housing that is mounted within the component cavity opposite the lower surface of the cavity and a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

According to yet another aspect of the present disclosure, a microwave oven includes a housing defining a cooking cavity and a component cavity external to the cooking cavity, a heating plate fixedly supported within the cooking cavity on a lower surface thereof and including an electric heating element disposed on at least a portion of the heating plate and defining first and second electric contact elements on an underside thereof, and a connection assembly for providing electricity to the electric heating element of the heating plate. The connection assembly has a connection housing that is mounted within the component cavity opposite the lower surface of the cavity and a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a microwave oven according to an aspect of the disclosure;

FIG. 2 is a front view of the microwave oven of FIG. 1;

FIG. 3 is a front cross-section view of the microwave showing internal components thereof;

FIG. 4 is a perspective view of a heating plate included in the heating assembly of the microwave oven;

FIG. 5 is a perspective cross-section view showing connection between the heating plate and a plurality of compliant connection components of the auxiliary heating assembly;

FIG. 6 is an assembly view of the heating plate within a cooking cavity of the microwave for connection with the connection components;

FIG. 7 is a perspective view of a cavity housing of the microwave oven with the auxiliary heating assembly in place thereon;

FIG. 8 is a perspective view of a connection assembly of the auxiliary heating assembly;

FIG. 9 is a cross-section view of the connection assembly;

FIG. 10 is a cross-section view of the microwave oven showing the axillary heating assembly; and

FIG. 11 is a cross-section view showing aspects of an alternative connection assembly.

The components in the figures are not necessarily to scale, emphasis instead being placed upon illustrating the principles described herein.

### DETAILED DESCRIPTION

The present illustrated embodiments reside primarily in combinations of method steps and apparatus components related to an auxiliary heating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

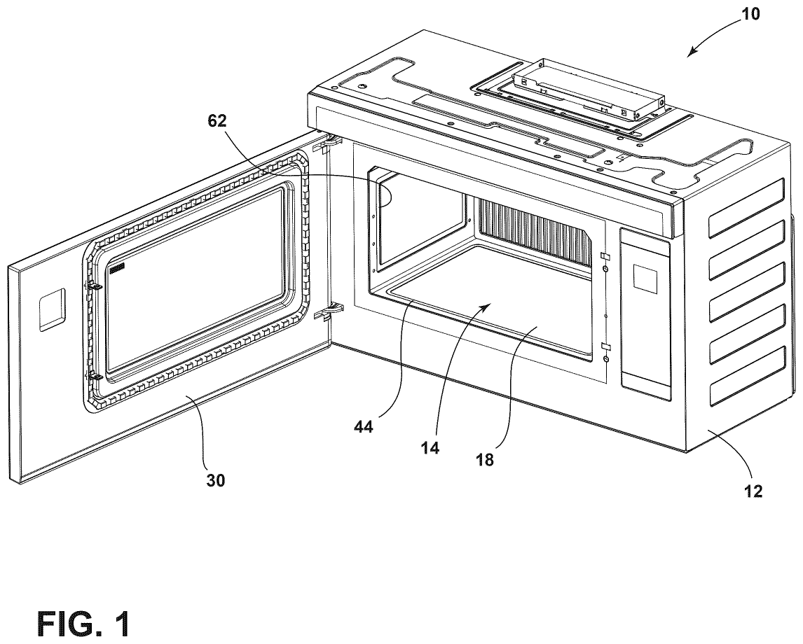

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

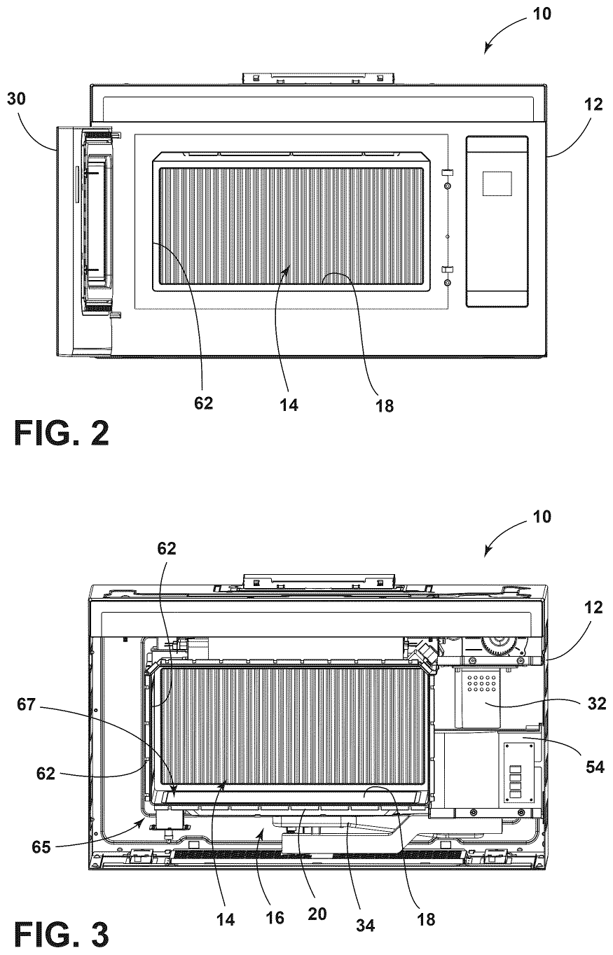

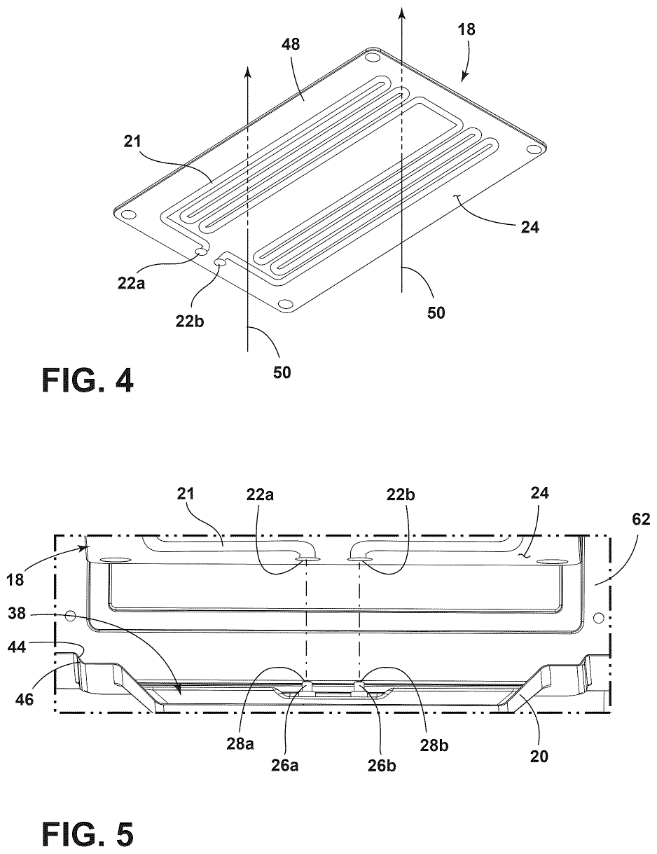

Referring to FIGS. 1-10, reference numeral 10 generally designates a microwave oven. As shown, the microwave oven 10 includes a housing 12 defining a cooking cavity 14 and a component cavity 16 (FIG. 3) external to the cooking cavity 14. A heating plate 18 is fixedly supported within the cooking cavity 14 on a lower surface 20 thereof and includes an electric heating element 21 (FIG. 4) disposed on at least a portion of the heating plate 18 and defining first and second electric contact elements 22a and 22b on an underside 24 thereof. A pair of conductive connection elements 26a and 26b are mounted within the component cavity 16 and extend through the lower surface 18 of the cooking cavity 14 to define respective ends 28a and 28b of the conductive connection elements 26a and 26b that are moveable with respect to the lower surface 18 of the cooking cavity 14 and are in contact with the first and second electric contact elements 22a and 22b of the heating plate 18.

As generally shown in FIG. 1, the microwave oven 10 includes a door 30 that opens and closes over an open side of the cooking cavity 14 to allow for the placement and removal of items to be heated into and from the cavity 14. In this respect, the illustrated configuration of door 30 with respect to the housing 12 and the cooking cavity 14 is merely illustrative, with it being understood that various door configurations are possible. Similarly, the configuration of the housing 12 and the portions of the cooking cavity 14 not specifically discussed herein can vary according to the principles discussed herein and to accommodate the various features described in further detail herein. In this manner, it is also to be appreciated that the microwave oven 10 can also include various forms of controls for operation of the microwave oven 10, including the various heating functionality discussed herein. Such controls can be digital, electromechanical, or combinations thereof and can be included on one or both of the doors 30 and the housing 12.

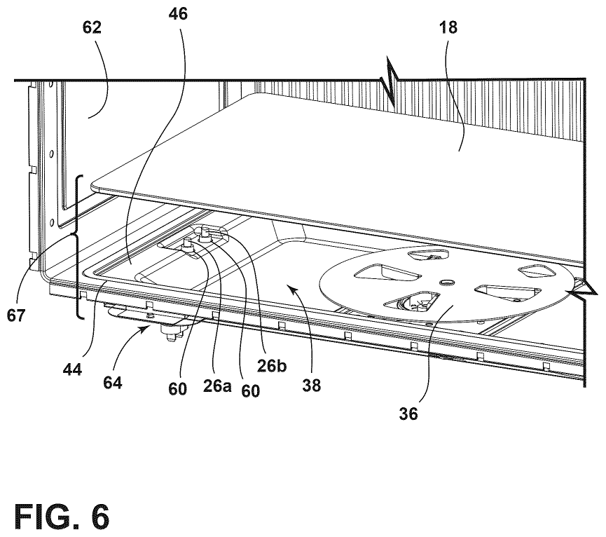

As shown, in FIGS. 4 and 5, in one aspect, the microwave oven 10 is configured for typical microwave operation, such that a magnetron 32 delivers micro-waves into the cooking cavity 14 to heat food products placed therein. In particular, the microwaves are directed through a microwave guide 34 toward a portion of the component cavity 16 beneath the lower surface 20 thereof. The microwaves are then directed to the lower surface 20 and distributed into the cooking cavity 14 by an antenna 36. As further shown in FIG. 6, the antenna 36 may be a directional structure rotatably supported within a lower sub-cavity 38 that is defined between the lower surface 20 of the cooking cavity 14 and an underside 24 of the heating plate 18. The antenna 36 is supported and rotated within the sub-cavity 38 by being coupled with a motor 40 within the component cavity 16. The motor 40 is configured to rotate the antenna 36 within the sub-cavity 38 to generally evenly distribute the micro-waves through the heating plate 18 and generally throughout cooking cavity 14.

As is generally accepted, the use of micro-waves to heat food items, such as using the magnetron 32, guide 34, and antenna 36 configuration can provide for rapid, even heating of such food articles, but may be considered deficient for browning or surface-caramelization of such items. In the illustrated microwave 10, the heating plate 18 can employ resistive-heating to provide radiant heat and/or conductive heating to food items within microwave oven 10, as radiant and conductive heat can provide desired browning to supplement the micro-wave heating provided by the magnetron 32. In this respect, the heating plate 18 can be configured to provide such heating over a large portion of a food-supporting surface 42 of the cavity 14, which is defined by the heating plate 18 by the same being fixed within the upper portion of the sub-cavity 38 (i.e., above the antenna 36). More particularly, the heating plate 18 can be secured an outer periphery 44 of the sub-cavity 38, where it is generally supported by a ledge 46 that extends inwardly therefrom. In various aspects, the heating plate 18 can be fixed by various flexible adhesives (e.g. silicon adhesives or the like) or by a press-fit defining gasket and/or combinations thereof. In this manner, the heating plate 18 is configured as a fixed portion of the cavity 14 (including for supporting food directly thereon, as discussed herein, or supporting other containers, plates, or the like thereon) and is not intended to be removed by the user, although it may be removable for servicing of the microwave 10, which may require access to antenna 36 or replacement of the heating plate 18. In various configurations, heating plate 18 can provide conductive and radiant heat to the downward-facing portions of food items placed directly on heating plate 18 and can provide radiant heating to items positioned on a rack suspended within the cooking cavity 14. In combination with the heating plate 18, the microwave 10 may also include an upper heating element 47 (such as a quartz heating tube) with an adjacent reflective area 49 for directing radiant heat from the heating element 47 downward toward food items within cooking cavity 14 to provide a broil/grill or crisping cooking mode, that may be selected in various modes by the user. Other combinations or implementations of these multiple heating assemblies are possible.

Due to the positioning of antenna 36 beneath heating plate 18, and the general configuration of microwave oven 10, in which the micro-waves generated by magnetron 32 are directed into cooking cavity 14 through the heating plate 18, in the various embodiments discussed herein, the heating plate 18 can be configured to allow for acceptable transmission of the micro-waves directed toward cooking cavity 14 therethrough. In the illustrated example, the heating plate 18 includes a body 48 defined by a glass-ceramic substrate 24 or other material that is permeable by micro-waves. As can be appreciated, glass-ceramic materials (and additional materials of a similar class, which may be substituted for the present “glass-ceramic” substrate material) are generally permeable by micro-waves, while various materials that can be applied to the body 48 to provide resistive heating are generally impermeable by and/or act to absorb micro-waves. In this manner, the heating element 21, as shown in FIG. 4 can be of a resistive heating material that is applied to the body 48 and is configured to cover less than the entire underside 24 of the heating plate 18 so as to provide open microwave-transmissive path(s) 50 is/are provided to allow transmission of an acceptable amount of the micro-waves (e.g. about 50%) emitted via antenna 36 to pass through the resulting portions of the glass-ceramic substrate 24 that remain uncovered by the heating element 21. Notably, depending on the particular material used for the resistive-heating coating 26, as well as the structure and arrangement of antenna 36, for example, the proportion of the coating 26 to the open micro-wave transmissive path 50 portions may vary and may not directly correspond with the amount of micro-waves transmitted through body 48.

In one embodiment, shown in FIG. 4, the heating plate 18 includes the above-described body 48 of a glass-ceramic substrate having a thickness sufficient for supporting food items thereon (e.g. between about 0.125 and 0.5 inches and in a further example between about 0.2 and 0.4 inches). In the illustrated embodiment, the heating element 21 consists of a trace pattern of a material including palladium, such as palladium-oxide applied on the lower surface 24 of the heating plate 18, as defined by the body 48. This can be done in various patterns to provide a generally even distribution of the resistive heating material body 48 for even generation of heat thereover. The trace pattern can provide a plurality of uncoated areas 52 between adjacent portions to define one or more of the above-mentioned open micro-wave transmissive paths 50. This spacing and resulting uncoated areas 52 can provide a sufficient number, size, and arrangement of open micro-wave transmissive paths 50 for transmission of micro-waves through body 48 to an acceptable amount and over an acceptable area for micro-wave heating of food items. Other examples of a heating plate configured for micro-wave transmission are discussed in co-pending, commonly-assigned U.S. patent application Ser. No. 17/320,375, the entire disclosure of which is incorporated by reference herein.

The microwave oven 10 further includes a power source 54 positioned within the component cavity 16 that is configured to distribute an electrical current received from an external power connection (e.g., a 110-Volt or 220-Volt outlet) to the internal components of the microwave, including the magnetron 32, the antenna motor 40, and the control system of the microwave oven 10, as well as the heating element 21 of the heating plate 18 and (optionally and/or selectively) the upper heating element 47. In this respect, the conductive connection elements 26a and 26b are connected with the power source 54 to provide electricity to the electric heating element of the heating plate 18 by connecting the power source 54 to the heating element 21 via the contact elements 22a and 22b that can be formed with the trace pattern of the heating element 21 at opposite ends thereof. Particularly, in the microwave oven 10 arrangement discussed herein, the conductive connection elements 26a and 26b can be visually concealed from within the cooking cavity 14 by the heating plate 18 by the illustrated positioning of the contact elements 22a and 22b being positioned on the underside 24 of the heating plate 18, which as discussed above, fits within the upper portion of the sub-cavity 38.

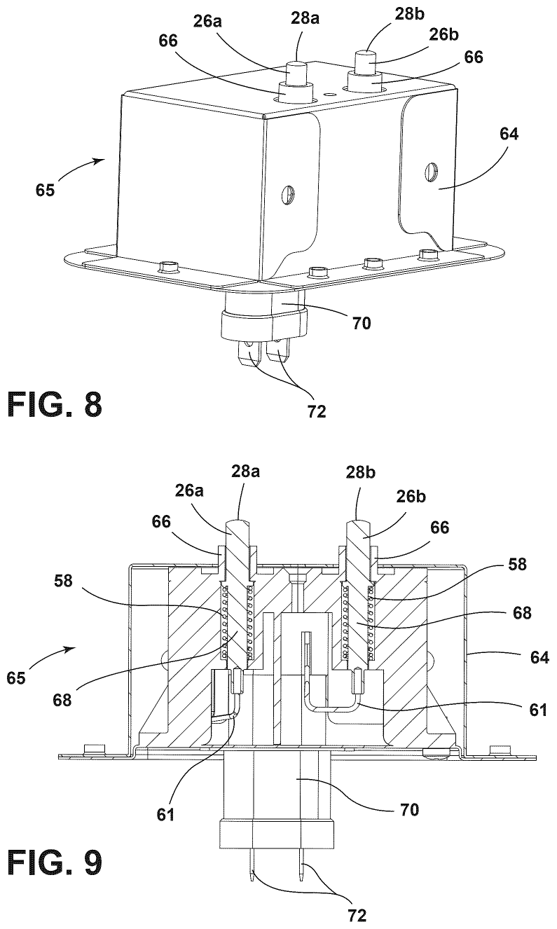

As shown in FIGS. 5 and 6, and in greater detail in FIGS. 8-10, each of the pair of conductive connection elements 26a and 26b can be a cylindrical body that is movably supported with respect to the lower surface 20 of the cooking cavity 14 and extends therethrough. The ends 28a and 28b of the conductive connection elements 26a and 26b are moveable with respect to the lower surface 20 by movement of the respective cylindrical body 26a and 26b on which they are defined. In this manner, the conductive connection elements 26a and 26b can be in the form of spring-biased “pogo” pins that respectively contact the contact elements 22a and 22b on the heating plate 18, either directly or by way of masses of conductive paste 56 applied between the ends 28a and 28b of the conductive connection elements 26a and 26b and the contact elements 22a and 22b, as shown in FIG. 10. The connection elements 26a and 26b are biased upwardly by springs 58 so as to extend upwardly through respective holes 60a and 60b in the lower surface 20 of the cooking cavity 14, above which the heating plate 18 is supported. The positioning of the heating plate 18 on the ledge 46 of the sub-cavity 38 presses the connection elements 26a and 26b downward from the fully-extended position shown in FIG. 6 to an intermediate position (FIG. 10) wherein the ends 28a and 28b can move upward and downward with extension or further compression of the springs 58. In this manner, the connection elements 26a and 26b have a degree of compliance when contacting the contact elements 22a and 22b of the heating plate 18, such that shifting or other movement of the heating plate 18 (such as movement caused by thermal deformation of the body 48) within an anticipated extent, does not electrically uncouple the contact elements 22a and 22b from the connection elements 26a and 26b, with the connection elements 26a and 26b moving upward and downward under, respectively, the weight of the heating plate 18 and the upward biasing of the springs 58. In the presently described use within microwave oven 10, the connection elements 26a and 26b are electrically connected, via leads 61 to the power source 54, with the leads being sized and configured to allow the movement of the connection elements 26a and 26b described herein.

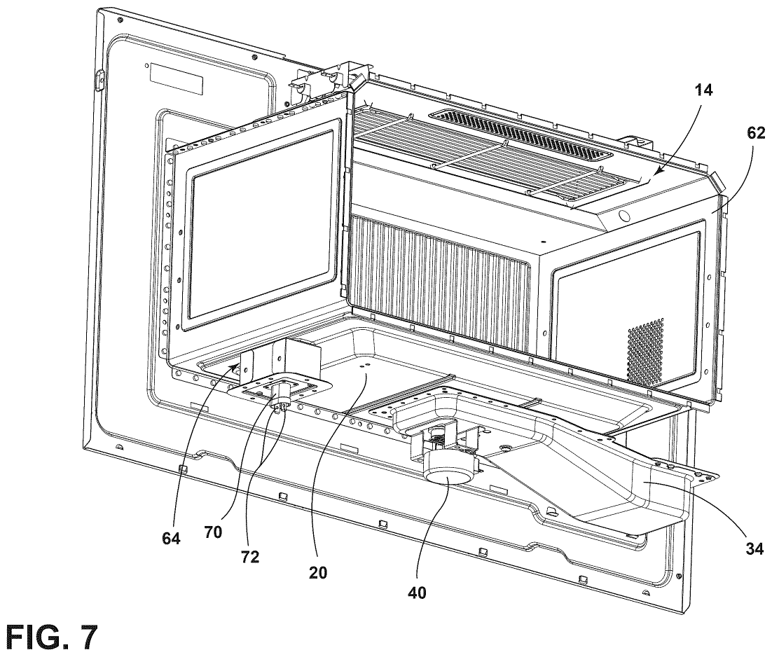

As shown in FIG. 7, in the microwave oven 10, the lower surface 20 of the cooking cavity 14 can be defined on a cavity housing 62 that is positioned within the outer housing 12 of the microwave oven 10 to separate the cooking cavity 14 from the component cavity 16. The connection elements 26a and 26b can be mounted in a connection housing 64 that is coupled to the cavity housing 62 opposite the lower surface 20 of the cooking cavity 14. In such a respect, the cavity housing 62, in combination with the connection elements 26a and 26b, springs 58, leads 61 and other related components discussed herein can comprise a connection assembly 65 that, in combination with the heating plate 18 can be considered an auxiliary heating assembly 67, according to the disclosure, that can be utilized with other variations of microwave ovens, in addition to the implementation of the microwave oven 10 shown in FIGS. 1-10, as well as other types of ovens and/or countertop cooking appliances.

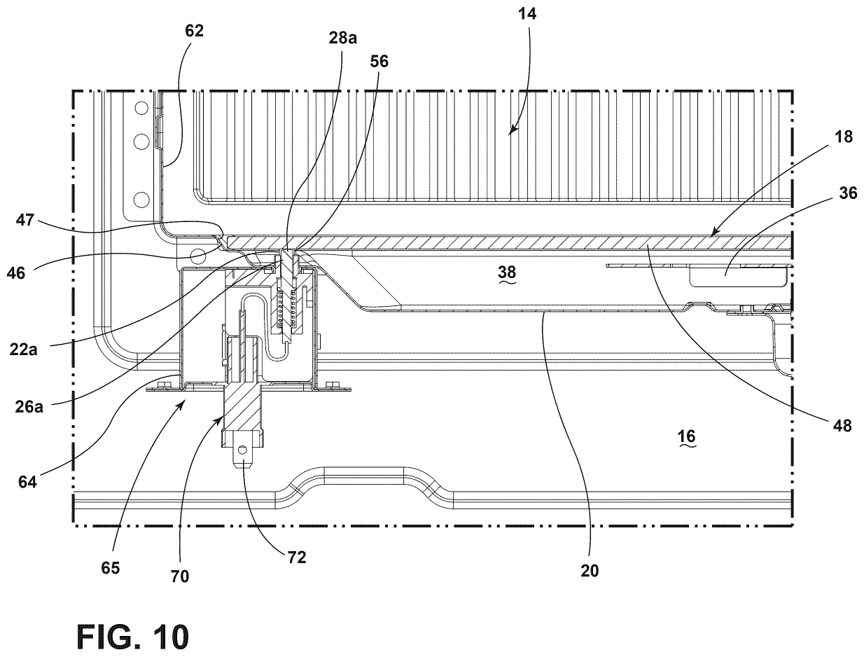

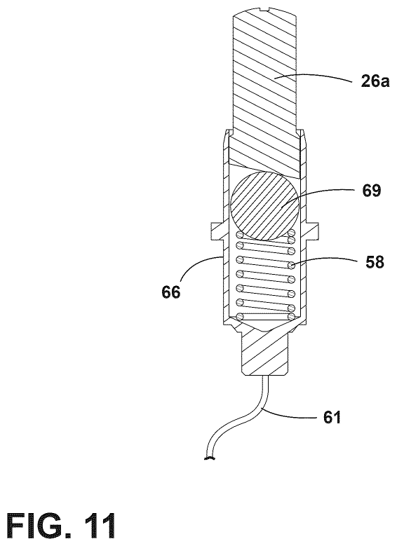

In the present example, the respective contact between the first and second contact elements 22a and 22b of the heating plate 18 urges the connection elements 26a and 26b, in the form of the depicted cylindrical bodies downward, partially into the connection housing 62, against the upward biasing force of the respective springs 58. As further shown in FIGS. 8 and 9, the connection elements 26a and 26b are placed within close proximity to each other so as to be received in the single connection housing 64. The specific structure of the connection elements 26a and 26b and interaction with the springs 58 and connection housing 62 can take various forms, one example of which is shown in FIGS. 9 and 10. In this example, the connection elements 26a and 26b and respective springs 58 can each be received in a non-conductive bezel 66 with a stem 68 of each of the connection elements 26a and 26b extending outward from the bezel 66. The above-described electrical connection to the respective leads 61 can be made with the stem 68, which can also support the corresponding spring 58 within the bezel 66. In specific examples, the connection elements 26a and 26b can be fabricated from or coated with silver for improved conductivity. In the example shown in FIG. 11, each connection element 26a and 26b is received in a conductive bezel 66′ that also retains the spring 58 and a bearing 69 positioned between the spring 58 and the corresponding connection element 26a or 26b. In such an example, the leads 61 can connect with the respective bezel 66′ to provide electrical connection therethrough to the respective connection elements 26a or 26b.

In either of the examples, discussed above, the connection assembly 65 can further include a connection unit 70 with which the leads 61 are connected, internal to the connection housing 64. In this manner, the connection unit 70 extends through a portion of the connection housing 64 such that external terminals 72 can be used for connection to the power source 54. In a specific example, the connection unit 70 can be a ceramic feed-through capacitor that is closely received within the connection housing 64 such that the connection unit 70 can act to block the escape of micro-waves that may pass through the holes 60 and into the connection housing 64. In other applications, such as in toaster ovens and the like, such structure may be omitted or altered to not include a feed-through capacitor.

The invention disclosed herein is further summarized in the following paragraphs and is further characterized by combinations of any and all of the various aspects described therein.

According to another aspect of the present disclosure, a microwave oven includes a housing defining a cooking cavity and a component cavity external to the cooking cavity and a heating plate fixedly supported within the cooking cavity on a lower surface thereof and including an electric heating element disposed on at least a portion of the heating plate and defining first and second electric contact elements on an underside thereof. A pair of conductive connection elements are mounted within the component cavity and extend through the lower surface of the cooking cavity to define respective ends of the conductive connection elements that are moveable with respect to the lower surface of the cooking cavity and are in contact with the first and second electric contact elements of the heating plate.

The microwave oven described in ¶[0035] can further include a power source positioned within the component cavity, wherein the conductive connection elements are connected with the power source to provide electricity to the electric heating element of the heating plate.

In the microwave oven described in either ¶¶[0035] or [0036], each of the pair of conductive connection elements can be a cylindrical body that is movably supported with respect to the lower surface of the cooking cavity and extends therethrough, the ends of the conductive connection elements being moveable with respect to the lower surface by movement of the respective cylindrical body.

In the microwave oven described in ¶[0037] the lower surface of the cavity can be defined on a cavity housing that is positioned within the component cavity, and the cylindrical bodies can be mounted in a connection housing that is coupled to the cavity housing opposite the lower surface of the cavity.

In the microwave oven described in ¶[0038], the cylindrical bodies can be spring biased against a portion of the housing to respectively urge the ends thereof into a fully-extended position within the cavity.

In the microwave oven described in ¶[0039], the respective contact between the first and second electric contact elements of the heating plate urges the cylindrical bodies into the connection housing against the spring bias.

In the microwave oven described in any of ¶¶[0037] to [0040], the cylindrical bodies can be electrically connected to a feedthrough capacitor mounted to and extending through the connection housing, the feedthrough capacitor being connected with the power source external to the connection housing.

The microwave oven described in any of ¶¶[0035] to [0041] can further include a conductive paste surrounding the respective ends of the conductive connection elements and coupling with the electric contact elements of the heating plate.

In the microwave oven described in any of ¶¶[0035] to [0042] the conductive connection elements can be visually concealed from within the cavity by the heating plate.

The microwave oven described in any of ¶¶[0035 to [0043] can further include a magnetron and a micro-wave antenna in electrical communication, both being positioned within the component cavity with the micro-wave antenna being adjacent the lower surface of the cooking cavity. The portion of the heating plate can include a glass-ceramic substrate defining at least a portion of a food-supporting surface within the cooking cavity, and the electric heating element can include a resistive-heating coating applied on a portion of the glass-ceramic substrate and defining at least one open micro-wave transmissive path from the micro-wave antenna to the cooking cavity.

According to yet another aspect, an auxiliary heating assembly for a cooking appliance having a housing defining a cooking cavity and a component cavity external to the cooking cavity can include a heating plate fixedly supported within the cooking cavity on a lower surface thereof and having an electric heating element disposed on at least a portion of the heating plate and defining first and second electric contact elements on an underside thereof and a connection assembly for provide electricity to the electric heating element of the heating plate. The connection assembly includes a connection housing that is mounted within the component cavity opposite the lower surface of the cavity and a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

In the auxiliary heating assembly described in ¶[0045] the cylindrical bodies can be spring biased against a portion of the housing to respectively urge the ends thereof into a fully-extended position within the cavity.

In the auxiliary heating assembly described in ¶[0046] the respective contact between the first and second electric contact elements of the heating plate may urge the cylindrical bodies into the connection housing against the spring bias.

In the auxiliary heating assembly described in any of ¶¶[0045] to [0047] the cylindrical bodies can be electrically connected to respective feedthrough capacitors mounted to and extending through the connection housing, the feedthrough capacitors being connected with a power source of the cooking appliance that is external to the connection housing.

The auxiliary heating assembly described in any of ¶¶[0045] to [0048] can further include a conductive paste surrounding the respective ends of the conductive connection elements and coupling with the electric contact elements of the heating plate.

According to yet another aspect, a microwave oven includes a housing defining a cooking cavity and a component cavity external to the cooking cavity a heating plate fixedly supported within the cooking cavity on a lower surface thereof and including an electric heating element disposed on at least a portion of the heating plate and defining first and second electric contact elements on an underside thereof, and a connection assembly for providing electricity to the electric heating element of the heating plate. The connection assembly has a connection housing that is mounted within the component cavity opposite the lower surface of the cavity and a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

In the microwave oven described in ¶[0050] the lower surface of the cavity can be defined on a cavity housing that is positioned within the component cavity, and the connection housing can be coupled to the cavity housing opposite the lower surface of the cavity.

In the microwave oven described in either of ¶¶[0050] or [0051], the cylindrical bodies can be spring biased against a portion of the housing to respectively urge the ends thereof into a fully-extended position within the cavity, and the respective contact between the first and second electric contact elements of the heating plate can urge the cylindrical bodies into the connection housing against the spring bias.

The microwave oven described in any of ¶¶[0050] to [0052] can further include a power source positioned within the component cavity, the conductive connection elements can be connected with the power source to provide electricity to the electric heating element of the heating plate, and the cylindrical bodies can be electrically connected to respective feedthrough capacitors mounted to and extending through the connection housing, the feedthrough capacitors being connected with the power source external to the connection housing.

The microwave oven described in any of ¶¶[0050] to [0053] can further include a conductive paste surrounding the respective ends of the conductive connection elements and coupling with the electric contact elements of the heating plate.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A microwave oven, comprising:
a housing defining a cooking cavity and a component cavity external to the cooking cavity;
a heating plate fixedly supported within the cooking cavity on a lower surface thereof and including an electric heating element disposed on at least a portion of the heating plate and defining first and second electric contact elements on an underside thereof;
a pair of conductive connection elements mounted within the component cavity and extending through the lower surface of the cooking cavity to define respective ends of the conductive connection elements that are moveable with respect to the lower surface of the cooking cavity and are in contact with the first and second electric contact elements of the heating plate.

2. The microwave oven of claim 1, further including a power source positioned within the component cavity, wherein:
the conductive connection elements are connected with the power source to provide electricity to the electric heating element of the heating plate.

3. The microwave oven of claim 1, wherein each of the pair of conductive connection elements is a cylindrical body that is movably supported with respect to the lower surface of the cooking cavity and extends therethrough, the ends of the conductive connection elements being moveable with respect to the lower surface by movement of the respective cylindrical body.

4. The microwave oven of claim 3, wherein:
the lower surface of the cavity is defined on a cavity housing that is positioned within the component cavity; and
the cylindrical bodies are mounted in a connection housing that is coupled to the cavity housing opposite the lower surface of the cooking cavity.

5. The microwave oven of claim 4, wherein the cylindrical bodies are spring biased against a portion of the cavity housing to respectively urge the ends thereof into a fully-extended position within the cooking cavity.

6. The microwave oven of claim 5, wherein the respective contact between the first and second electric contact elements of the heating plate urges the cylindrical bodies into the connection housing against the spring bias.

7. The microwave oven of claim 4, wherein the cylindrical bodies are electrically connected to a feedthrough capacitor mounted to and extending through the connection housing, the feedthrough capacitor being connected with the power source external to the connection housing and being configured with the connection housing to block an escape of micro-waves entering the connection housing from the cooking cavity from entering the component cavity.

8. The microwave oven of claim 1, further including a conductive paste surrounding the respective ends of the conductive connection elements and coupling with the electric contact elements of the heating plate.

9. The microwave oven of claim 1, wherein the conductive connection elements are visually concealed from within the cooking cavity by the heating plate.

10. The microwave oven of claim 1, further including a magnetron and a micro-wave antenna in electrical communication, both being positioned within the component cavity with the micro-wave antenna being adjacent the lower surface of the cooking cavity, wherein:
the portion of the heating plate includes a glass-ceramic substrate defining at least a portion of a food-supporting surface within the cooking cavity; and
the electric heating element includes a resistive-heating coating applied on a portion of the glass-ceramic substrate and defining at least one open micro-wave transmissive path from the micro-wave antenna to the cooking cavity.

11. An auxiliary heating assembly for a cooking appliance having a housing defining a cooking cavity and a component cavity external to the cooking cavity, the auxiliary heating assembly comprising:
a heating plate fixedly supported within the cooking cavity on a lower surface thereof and including an electric heating element disposed on at least a portion of the heating plate and defining first and second electric contact elements on an underside thereof; and
a connection assembly to provide electricity to the electric heating element of the heating plate, including:
a connection housing that is mounted within the component cavity opposite the lower surface of the cooking cavity; and
a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

12. The auxiliary heating assembly of claim 11, wherein the cylindrical bodies are spring biased against a portion of the connection housing to respectively urge the ends thereof into a fully-extended position within the cooking cavity.

13. The auxiliary heating assembly of claim 12, wherein the respective contact between the first and second electric contact elements of the heating plate urge the cylindrical bodies into the connection housing against the spring bias.

14. The auxiliary heating assembly of claim 11, wherein the cylindrical bodies are electrically connected to respective feedthrough capacitors mounted to and extending through the connection housing, the feedthrough capacitors being connected with a power source of the cooking appliance that is external to the connection housing and being configured with the connection housing to block an escape of micro-waves entering the connection housing from the cooking cavity from entering the component cavity.

15. The auxiliary heating assembly of claim 11, further including a conductive paste surrounding the respective ends of the conductive connection elements and coupling with the electric contact elements of the heating plate.

16. A microwave oven, comprising:
a housing defining a cooking cavity and a component cavity external to the cooking cavity;
a heating plate fixedly supported within the cooking cavity on a lower surface thereof and including an electric heating element disposed on at least a portion of the heating plate and defining first and second electric contact elements on an underside thereof; and
a connection assembly to provide electricity to the electric heating element of the heating plate, including:
a connection housing that is mounted within the component cavity opposite the lower surface of the cavity; and
a pair of conductive connection elements in the form of cylindrical bodies mounted within the connection housing and extending through the lower surface of the cooking cavity to define respective ends that are moveable with respect to the lower surface of the cooking cavity and are in contact with the first and second electric contact elements of the heating plate.

17. The microwave oven of claim 16, wherein:
The lower surface of the cooking cavity is defined on a cavity housing that is positioned within the component cavity; and
the connection housing is coupled to the cavity housing opposite the lower surface of the cooking cavity.

18. The microwave oven of claim 16, wherein:
the cylindrical bodies are spring biased against a portion of the connection housing to respectively urge the ends thereof into a fully-extended position within the cooking cavity; and
the respective contact between the first and second electric contact elements of the heating plate urges the cylindrical bodies into the connection housing against the spring bias.

19. The microwave oven of claim 16, further including a power source positioned within the component cavity, wherein:
the conductive connection elements are connected with the power source to provide electricity to the electric heating element of the heating plate; and
the cylindrical bodies are electrically connected to a feedthrough capacitor mounted to and extending through the connection housing, the feedthrough capacitor being connected with the power source external to the connection housing and being configured with the connection housing to block an escape of micro-waves entering the connection housing from the cooking cavity from entering the component cavity.

20. The microwave oven of claim 16, further including a conductive paste surrounding the respective ends of the conductive connection elements and coupling with the electric contact elements of the heating plate.
